(19) United States
(12) Patent Application Publication
(10) Pub. No.: US 2013/0128167 A1
(43) Pub. Date: May 23, 2013

(54) LIQUID CRYSTAL DISPLAY DEVICE

(71) Applicants: Minghung Shih, Shenzhen (CN); Zuomin Liao, Shenzhen (CN)

(72) Inventors: Minghung Shih, Shenzhen (CN); Zuomin Liao, Shenzhen (CN)

(73) Assignee: SHENZHEN CHINA STAR OPTOELECTRONICS TECHNOLOGY CO., LTD., Shenzhen (CN)

(21) Appl. No.: 13/379,873

(22) PCT Filed: Nov. 24, 2011
(86) PCT No.: PCT/CN11/82828

§ 371 Date: Dec. 21, 2011

(30) Foreign Application Priority Data
Nov. 18, 2011 (CN) 201110369523.X

(51) Int. Cl. G02F 1/1343; G02F 1/1368

(52) U.S. Cl. 349/42

(57) ABSTRACT

The present invention discloses a liquid crystal display device having a plurality of pixel areas defined by gate lines and data lines, and having a plurality of pixel units. Each pixel unit has a transistor, a pixel electrode, a common electrode and at least one connecting portion. The pixel electrode is connected to a drain of the transistor. The common electrode is connected to a corresponding common line and overlapped with the pixel electrode. The connecting portion is coplanar with the common electrode and connected to the common electrode, and insulatedly passes the gate line to connect with the common electrode of the pixel unit in an adjacent one of the pixel areas. With the above structure, the liquid crystal display device can provide better aperture ratio and transmittance.

### FIELD OF THE INVENTION

The present invention relates to a liquid crystal display device, and more particularly to a liquid crystal display device providing better aperture ratio and transmittance.

### BACKGROUND OF THE INVENTION

With reference FIG. 1, FIG. 1 is a plane view of a pixel unit of a conventional liquid crystal display device. The pixel unit is disposed in a pixel area defined by a gate line 90 and a data line 92, and comprises a common line 91, a transistor, a pixel electrode 94 and a common electrode 95. The common line 91 is parallel with the gate line 90. The transistor has a gate, a semiconductor layer 93, a source 921 and a drain 922, wherein the gate is the gate line 90, the semiconductor layer 93 is mounted on the gate line 90, and the source 921 is extended from the data line 92 and mounted on the semiconductor layer 93. The drain 922 is mounted on the semiconductor layer 93 and a side thereof is parallel with the source 921. The pixel electrode 94 is mounted in the pixel area and connected to the drain 922 via a through hole 920, and has a plurality of slots 940. The common electrode 96 is overlapped with the pixel electrode 94 and connected to the common line 91. Furthermore, the common electrode 95 is connected correspondingly to another common electrode 95 of the adjacent pixel area by insulatedly crossing the gate line 90 via a bridge unit 96 at a corner of the pixel area, wherein the common line 91 and the gate line 90 first have an insulating layer mounted thereon, and then the insulating layer has a through hole 960 formed thereon that is corresponding to the corner of the pixel area, and the bridge unit 96 then is connected to the common line 91 via the through hole 960.

With the bridge unit 96 connecting the common lines 91 in series can make the common lines of the entire pixel array to construct a mesh configuration, such mesh configuration can reduce floating of the electric potential of the common lines and thereby is helpful for reducing crosstalk.

However, because the mesh configuration is to form a through hole 960 in the pixel area and then use a bridge unit 96 to connect the common lines 91, the aperture ratio of the pixel area is therefore reduced.

Hence, it is necessary to provide a liquid crystal display device to overcome the problems existing in the conventional technology.

### SUMMARY OF THE INVENTION

In view of the shortcomings described in the prior art, a primary object of the invention is to provide a liquid crystal display device to solve the technical problem that the conventional liquid crystal display device with mesh structure design has low aperture ratio.

To achieve the above object, the present invention provides a liquid crystal display device which comprises:
a plurality of gate lines;
a plurality of data lines crossing the gate lines to define a plurality of pixel areas;
a plurality of common lines crossing the data lines and being parallel with the gate lines;
a plurality of pixel units respectively disposed in the plurality of pixel areas, and each of the pixel units includes a transistor, a pixel electrode, a common electrode and at least one connecting portion, and the pixel electrode is disposed in the pixel area and connected to a drain of the transistor and has a plurality of slots; the common electrode is connected to a corresponding one of the common lines and overlapped with the pixel electrode; and the connecting portion is coplanar with the common electrode, connected to the common electrode and insulatedly passes the gate line to connect with another common electrode of another pixel unit in the adjacent pixel area.

In one embodiment of the present invention, the transistor has a gate, a semiconductor layer, a source and a drain, and the gate is one of the gate lines, the semiconductor layer is mounted on the gate, the source is extended from one of the data lines and disposed on the semiconductor layer, and the drain is mounted on the semiconductor layer.

In one embodiment of the present invention, the gate line corresponds to one of the pixel areas to have two first conductor layers and a second conductor layer; the two first conductor layers are separated by an interval; two ends of the second conductor layer are connected to the first conductor layers, respectively; and the connecting portion is insulatedly extended between the opposite ends of the two first conductor layers under the second conductor layer.

In one embodiment of the present invention, an insulating layer is mounted on surfaces of the two first conductor layers and the connecting portion; the insulating layer has through holes formed correspondingly to the opposite ends of the two first conductor layers; and the two ends of the second conductor layer are connected to the opposite ends of the two first conductor layers via the through holes.

In one embodiment of the present invention, the slots of the pixel electrode are arranged parallel to each other.

In one embodiment of the present invention, the material of the connecting portion and the common electrode is a transparent conductive material, and the connecting portion is an extension of the common electrode.

In one embodiment of the present invention, the material of the connecting portion and the common electrode is indium tin oxide.

The present invention further provides a liquid crystal display device, and the liquid crystal display device comprises:
a plurality of gate lines;
a plurality of data lines crossing the gate lines to define a plurality of pixel areas;
a plurality of common lines crossing the data lines and being parallel with the gate lines; and
a plurality of pixel units respectively disposed in the plurality of pixel areas, and each of the pixel units includes a transistor, a pixel electrode, a common electrode and at least one connecting portion, and the pixel electrode is disposed in the pixel area and connected to a drain of the transistor and has a plurality of slots, the slots are arranged parallel to each other; the common electrode is connected to a corresponding one of the common lines and overlapped with the pixel electrode; and the connecting portion is coplanar with the common electrode, connected to the common electrode and insulatedly passing the gate line to connect another common electrode of another pixel unit in the adjacent pixel area, wherein the gate line corresponds to one of the pixel areas to have two first conductor layers and a second conductor layer; the two first conductor layers are separated by an interval; two ends of the second conductor layer are connected to the first conductor layers, respectively; and the connecting portion is insulatedly extended between the opposite ends of the two first conductor layers under the second conductor layer.

The present invention is mainly to further form a connecting portion that connects adjacent common electrodes on the surface where the common electrodes are formed, so as to solve the shortcoming of conventional technologies that forming through holes in pixel areas leads to low aperture ratio.

### DESCRIPTION OF THE DRAWINGS

FIG. 1 is a plane view of a pixel unit of a conventional liquid crystal display device;

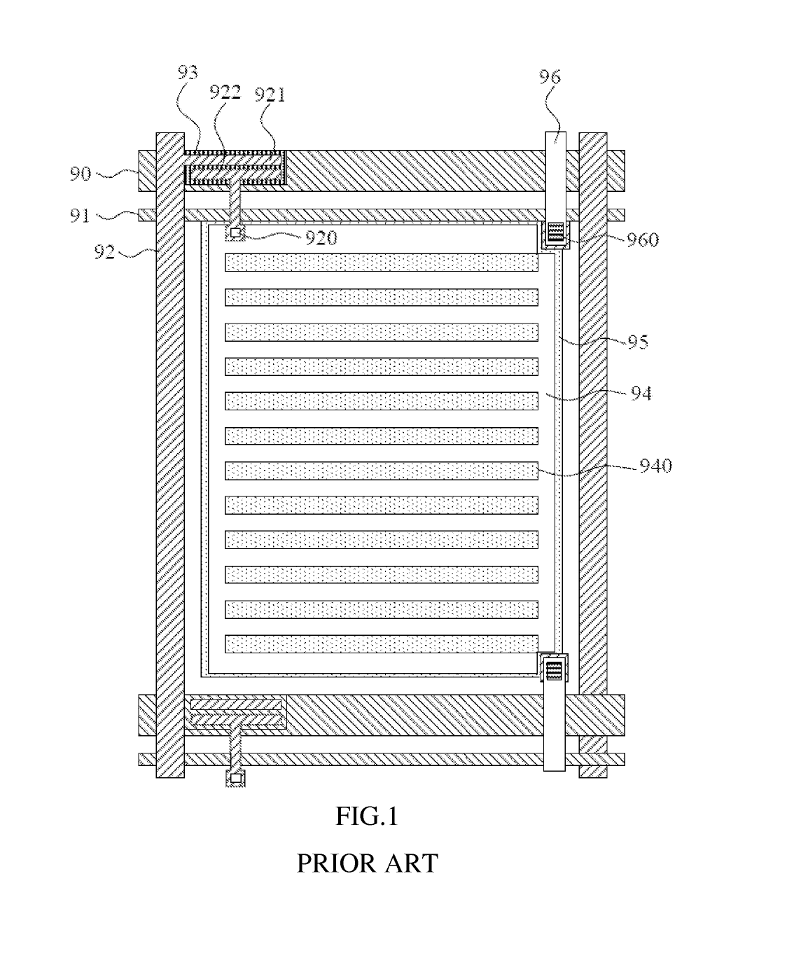

FIG. 2 is a plane view of a pixel unit of a preferred embodiment of a liquid crystal display device in accordance with the present invention; and

FIG. 3 is a cross-sectional side view along line A-A in FIG. 2.

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

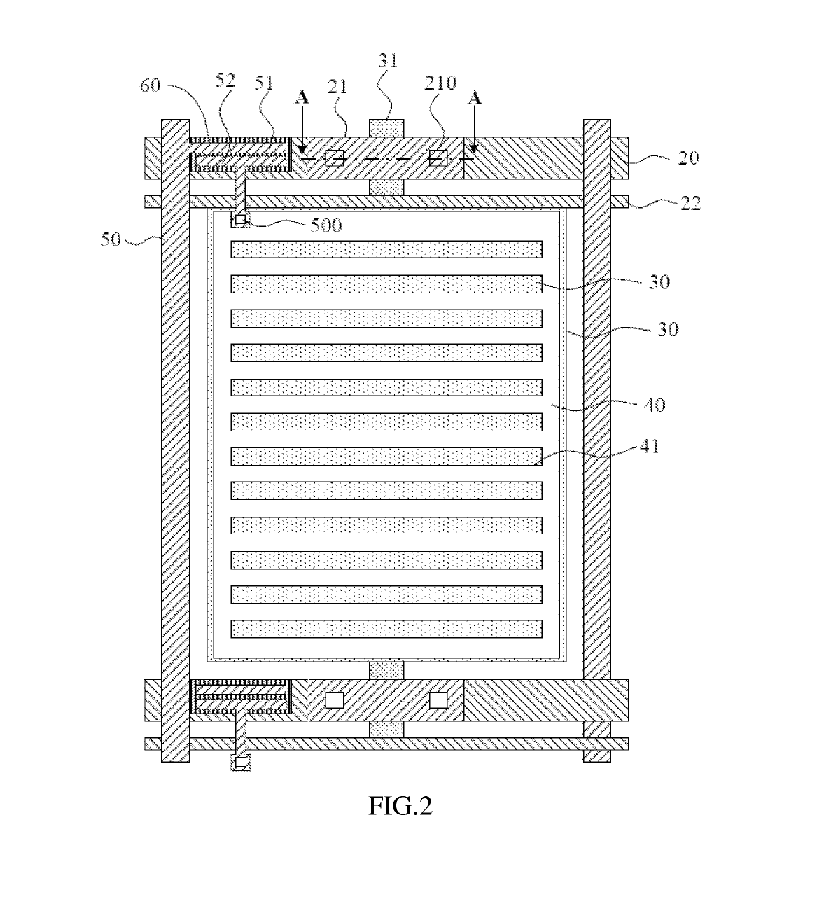

With reference to FIG. 2, FIG. 2 is a plane view of a pixel unit of a preferred embodiment of a liquid crystal display device in accordance with the present invention. The liquid crystal display device comprises a plurality of gate lines 20, a plurality of data lines 50, a plurality of common lines 22 and a plurality of pixel units. The gate lines 20 cross the data lines to define a plurality of pixel areas. The common lines 22 cross the data lines 50 and are parallel with the gate lines 20. The pixel units are respectively disposed in the plurality of pixel areas, and each of the pixel units includes a transistor, a pixel electrode 40, a common electrode 30 and at least one connecting portion 31.

The pixel electrode 40 is disposed in the pixel area, and is connected to a drain 52 of the transistor and has a plurality of slots 41, wherein the pixel electrode 40 is connected to an extension of the drain 52 via a through hole 500 of an insulated layer. In this embodiment, the slots 41 of the pixel electrode 40 are preferably arranged parallel to each other.

The common electrode 30 is connected to a corresponding one of the common lines 22 and overlapped with the pixel electrode 40.

The connecting portion 31 is coplanar with the common electrode 30 and is connected to the common electrode 30, and insulatedly passes the gate line 20 to connect with another common electrode of another pixel unit in the adjacent pixel area. In this embodiment, the material of the connecting portion 31 and the common electrode 30 is a transparent conductive material and is preferably indium tin oxide. The connecting portion 31 is preferably an extension of the common electrode 30.

The transistor comprises a gate, a semiconductor 60, a source 52 and a drain 51. The gate is one of the gate lines 20. The semiconductor layer 60 is mounted on the gate. The source 52 is extended from one of the data lines 50 and disposed on the semiconductor layer 60. The drain 52 is mounted on the semiconductor layer 60.

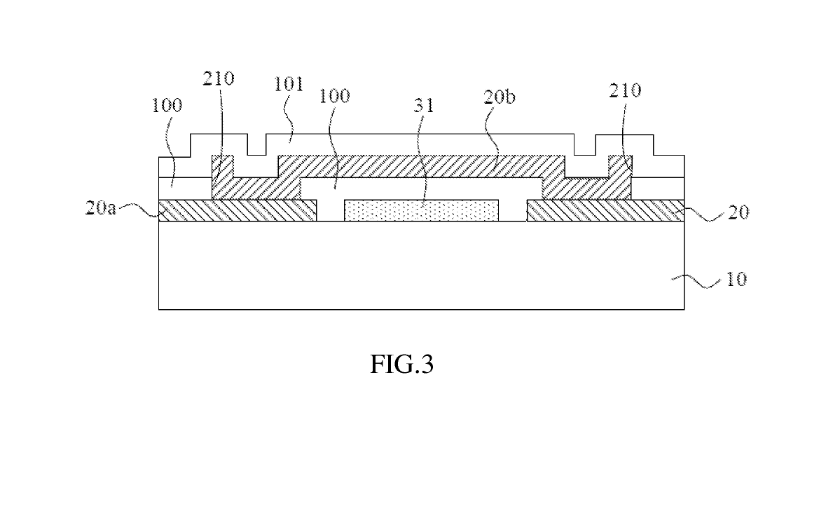

With further reference to FIG. 3, FIG. 3 is a cross-sectional side view along line A-A in FIG. 2 The gate line 20 corresponds to one of the pixel areas to have two first conductor layers 20a and a second conductor layer 20b. The two first conductor layers 20a are separated by an interval. Two ends of the second conductor layer 20b are connected to the first conductor layers 20a, and the connecting portion 31 is insulatedly extended between the opposite ends of the two first conductor layers 20a under the second conductor layer 20b. To be more detailed, an insulating layer 100 is mounted on surfaces of the two first conductor layers 20a and the connecting portion 31; the insulating layer 100 has through holes 210 formed correspondingly to the opposite ends of the two first conductor layers 20a; and the two ends of the second conductor layer 20b are connected to the opposite ends of the two first conductor layers 20a via the through holes 210. Therefore, the present invention can connect adjacent common electrodes 30 using the connecting portion 31, the common lines 22 that are connected the common electrodes 30 can thereby construct a mesh configuration, which also reduce floating of the electric potential of the common lines 22 and thereby is helpful for reducing crosstalk.

Comparing with the mesh configuration of common lines of the conventional liquid crystal display device which needs to form through holes in pixel areas and uses bridge units to cross over the top of a gate line to connect with a common line, and thereby causes a problem of low aperture ratio, the liquid crystal display device of the present invention makes the common electrode which is under the pixel electrode to have a connecting portion extended from one side thereof so as to insulatedly pass a bottom of the gate line without forming through holes in the pixel area, and thereby is helpful for enhancing the aperture ratio of the pixel area and the transmittance of liquid crystal panel, and further reducing the power consumption of the liquid crystal display device.

The present invention has been described with a preferred embodiment thereof and it is understood that many changes and modifications to the described embodiment can be carried out without departing from the scope and the spirit of the invention that is intended to be limited only by the appended claims.

1. A liquid crystal display device, characterized in that: the liquid crystal display device comprises:
a plurality of gate lines;
a plurality of data lines crossing the gate lines to define a plurality of pixel areas;
a plurality of common lines crossing the data lines and being parallel with the gate lines; and
a plurality of pixel units respectively disposed in the plurality of pixel areas, and each of the pixel units includes a transistor, a pixel electrode, a common electrode and at least one connecting portion, and the pixel electrode is disposed in the pixel area and connected to a drain of the transistor and has a plurality of slots, the slots are arranged parallel to each other; the common electrode is connected to a corresponding one of the common lines and overlapped with the pixel electrode; and the connecting portion is coplanar with the common electrode, connected to the common electrode and insulatedly passing the gate line to connect another common electrode of another pixel unit in the adjacent pixel area, wherein the gate line corresponds to one of the pixel areas to have two first conductor layers and a second conductor layer; the two first conductor layers are separated by an interval; two ends of the second conductor layer are connected to the first conductor layers, respectively; and the connecting portion is insulatedly extended between the opposite ends of the two first conductor layers under the second conductor layer.

2. A liquid crystal display device, characterized in that: the liquid crystal display device comprises:
a plurality of gate lines;
a plurality of data lines crossing the gate lines to define a plurality of pixel areas;
a plurality of common lines crossing the data lines and being parallel with the gate lines;
a plurality of pixel units respectively disposed in the plurality of pixel areas, and each of the pixel units includes a transistor, a pixel electrode, a common electrode and at least one connecting portion, and the pixel electrode is disposed in the pixel area and connected to a drain of the transistor and has a plurality of slots; the common electrode is connected to a corresponding one of the common lines and overlapped with the pixel electrode; and the connecting portion is coplanar with the common electrode, connected to the common electrode and insulatedly passes the gate line to connect with another common electrode of another pixel unit in the adjacent pixel area.

3. The liquid crystal display device as claimed in claim 2, characterized in that:
the transistor has a gate, a semiconductor layer, a source and a drain, and the gate is one of the gate lines, the semiconductor layer is mounted on the gate, the source is extended from one of the data lines and disposed on the semiconductor layer, and the drain is mounted on the semiconductor layer.

4. The liquid crystal display device as claimed in claim 2, characterized in that:
the gate line corresponds to one of the pixel areas to have two first conductor layers and a second conductor layer; the two first conductor layers are separated by an interval; two ends of the second conductor layer are connected to the first conductor layers, respectively; and the connecting portion is insulatedly extended between the opposite ends of the two first conductor layers under the second conductor layer.

5. The liquid crystal display device as claimed in claim 4, characterized in that:
an insulating layer is mounted on surfaces of the two first conductor layers and the connecting portion; the insulating layer has through holes formed correspondingly to the opposite ends of the two first conductor layers; and the two ends of the second conductor layer are connected to the opposite ends of the two first conductor layers via the through holes.

6. The liquid crystal display device as claimed in claim 2, characterized in that:
the slots of the pixel electrode are arranged parallel to each other.

7. The liquid crystal display device as claimed in claim 2, characterized in that:
the material of the connecting portion and the common electrode is a transparent conductive material, and the connecting portion is an extension of the common electrode.

8. The liquid crystal display device as claimed in claim 7, characterized in that:
the material of the connecting portion and the common electrode is indium tin oxide.
